(19) United States
(12) Patent Application Publication
(10) Pub. No.: US 2025/0116286 A1
(43) Pub. Date: Apr. 10, 2025

(54) A CLAMP DEVICE AND A METHOD OF CONNECTING SUCH A CLAMP DEVICE ONTO A CYLINDRICAL ELEMENT

(71) Applicant: Torsion Tool Company AS, STAVANGER (NO)

(72) Inventor: Olav OLSEN, STAVANGER (NO)

(21) Appl. No.: 18/730,170

(22) PCT Filed: Jan. 13, 2023
(86) PCT No.: PCT/NO2023/050005

§ 371 Date: Jul. 18, 2024

(30) Foreign Application Priority Data
Jan. 21, 2022 (NO) 20220086

(51) Int. Cl. F16B 7/04; F16B 2/14

(52) U.S. Cl. CPC F16B 7/0413; F16B 2/14

(57) ABSTRACT

A clamp device includes an inner member for assembly onto a cylindrical element, and the inner member includes an inner surface for releasable contact with a portion of the cylindrical element outer surface. The inner member includes an outer surface with an outward-facing conical shape. The clamp device also includes an outer member having an inner surface defining an inward-facing conical shape; wherein the inward-facing conical shape is complementary with the outward-facing conical shape, whereby when the outer member is assembled onto the inner member, a wedge effect is generated when the outer member is moved in the longitudinal direction. Either the inner member or the outer member includes sealing means that define an area on the respective member, whereby the area defines a sealed cavity between the inner and outer members. At least one of the outer member or the inner member includes a fluid port.

### TECHNICAL FIELD OF THE INVENTION

The invention relates to a device configured for connection to an outer surface of a cylindrical member such as a pipe, rod, or other tubular or rod shaped members. More specifically, the invention concerns a clamp device as set out in the preamble of claim 1, and a method of connecting the clamp device as set out by the preamble of claim 8.

### BACKGROUND OF THE INVENTION

A clamp may be used for mechanically connecting an element to an outer surface of a cylindrical element such as a pipe, rod, or other tubular or rod shaped members. The clamp may serve as a holding device or support for one or more elements that abut against, are attached to, or are integrated in the clamp. Several clamps may be connected to a pipe, rod, or similar to form collars, centralizers, stabilizers, cable supports, cable guides, or stops.

For example, U.S. Pat. No. 6,910,534 B2 describes a clamp assembly that encloses a sensor and clamps around a tubing sting. The clamp assembly includes a plurality of contact members that provide stable contact points between the well casing and the clamp assembly.

As another example, US 2015/0047856 A1 describes a stop collar for a tubular. The stop collar includes a flexible member extending circumferentially around the tubular more than once. A tension force on the flexible member causes the flexible member to apply a radially-inward gripping force on the tubular. The stop collar may also or instead include an adhesive disposed radially between the flexible member and the tubular.

As yet another example, WO 2012/164513 A2 describes a clamp assembly for connecting at a downhole tool to a tubing in a well. The clamp assembly is provided with a first clamp part, a second clamp part, a hinge assembly, and a fastener. The first clamp part has at least one connection capable of receiving and securing the downhole tool. The fastener connects the first clamp part to the second clamp part when the first clamp part and the second clamp part are in the closed position. First and second inner clamp surfaces are sized and dimensioned to grip the tubing when the first clamp part and the second clamp part are in the closed position.

The prior art also includes U.S. Pat. No. 5,860,760 A, which describes a gripping device having an inner member and an outer member. The inner member has a split which defines a first end and a second end, and a selectively operable device is included to keep the first and second ends apart to permit the device to be placed around an object and to permit the first and second ends to move towards each other so that the inner member grips an object.

The prior art also includes WO 2014/011056 A1, which describes an attachment device for an element made to be arranged on a downhole tubular body. An end portion of a sleeve which is arranged to surround a portion of the tubular body is provided with an attachment portion which includes at least one clamping element arranged for radial displacement by the abutment of an abutment surface against a conical abutment portion (142) of a surrounding adapter sleeve.

### SUMMARY OF THE INVENTION

The invention is set forth and characterized in the main claim, while the dependent claims describe other characteristics of the invention.

It is thus provided a clamp device having a longitudinal axis and comprising an inner member for assembly onto a cylindrical element, wherein the inner member comprises an inner surface for releasable contact with a portion of the cylindrical element outer surface; characterized in that:
the inner member comprises an outer surface with an outward-facing conical shape; and
the clamp device further comprises an outer member having an inner surface defining an inward-facing conical shape;
wherein the inward-facing conical shape is complementary with the outward-facing conical shape, whereby when the outer member is assembled onto the inner member, a wedge effect is generated when the outer member is moved in the longitudinal direction;
wherein either the inner member or the outer member comprises sealing means that define an area on the respective member, whereby the area defines a sealed cavity between the inner and outer members; and
at least of the outer member or the inner member comprises a fluid port, whereby a fluid may be injected into the sealed cavity.

In one embodiment, the inner member comprises one or more friction-enhancing portions for releasable engagement with a portion of the cylindrical element.

In one embodiment, the inner member comprises a slit extending along the longitudinal axis in the entire length of the inner member. The outer member may comprise guide means that engage at least a portion of the slit, whereby the outer member is prevented from rotating around the longitudinal axis.

In one embodiment, the inner member comprises a first collar at a first end and a second collar at a second end. The fluid port is arranged within the area. In one embodiment, the fluid port and the guide means are arranged at diametrically opposite sides on the outer member.

It is also provided a method of connecting the invented clamp device onto a cylindrical element having a longitudinal axis, characterized by:
arranging the clamp device on a circumferential portion of the cylindrical element;
injecting a fluid into the sealed cavity via the fluid port, at a fluid pressure sufficient to cause temporary elastic deformation in at least the outer member;
moving the outer member axially on the inner member in order to generate a wedge effect by virtue of said conical shapes; and
releasing the fluid pressure in order to lock the elastic deformation against the cylindrical element.

### BRIEF DESCRIPTION OF THE DRAWINGS

These and other characteristics of the invention will become clear from the following description of two embodiments of the invention, given as non-restrictive examples, with reference to the attached schematic drawings, wherein:

FIG. 1 is a perspective view of a first embodiment of the clamp device according to the invention, in a position prior to assembly on a cylindrical element such as a pipe, tubular, or rod;

FIG. 2 is a perspective view of the inner member of the clamp device illustrated in FIG. 1;

FIG. 3 is a sectional side view of the inner member illustrated in FIG. 2, the section taken along section line X-X as identified in FIG. 1;

FIG. 4 is a side view of the inner member illustrated in FIG. 2;

FIG. 5 is a perspective view of the outer member of the clamp device illustrated in FIG. 1;

FIG. 6 is a sectional perspective view of the outer member illustrated in FIG. 5, the section taken along section line X-X as identified in FIG. 1;

FIG. 7 corresponds to FIG. 1 and illustrates the clamp device placed on the cylindrical element but prior to activation;

FIG. 8 is an enlarged sectional perspective view of the assembly illustrated in FIG. 7, taken along section line X-X as identified in FIG. 7;

FIG. 9 is an enlarged sectional perspective view of the assembly illustrated in FIG. 7, taken along section line X-X as identified in FIG. 7;

FIG. 10 corresponds to FIG. 7 and illustrates the clamp device in a clamped connection to the cylindrical element;

FIG. 11 is a perspective view of the inner member of a second embodiment of the clamp device according to the invention;

FIG. 12 is a sectional side view of the inner member illustrated in FIG. 11, the section taken along section line X-X as identified in FIG. 12;

FIG. 13 is a side view of the inner member illustrated in FIG. 11;

FIG. 14 is a perspective view of the outer member of a second embodiment of the clamp device according to the invention;

FIG. 15 is a sectional perspective view of the outer member illustrated in FIG. 14, the section taken along a section line corresponding to the section line X-X identified in FIG. 12;

FIG. 16 corresponds to FIG. 14, but illustrates the outer member from another perspective;

FIG. 17 corresponds to FIG. 15, but is a sectional side view.

FIG. 18 is a perspective, transparent, view of an embodiment of the inner member; and

FIG. 19 is an enlarged view of a portion of the embodiment illustrated in FIG. 18.

### DETAILED DESCRIPTION OF EMBODIMENTS OF THE INVENTION

The following description may use terms such as “horizontal”, “vertical”, “lateral”, “back and forth”, “up and down”, “upper”, “lower”, “inner”, “outer”, “forward”, “rear”, etc. These terms generally refer to the views and orientations as shown in the drawings and that are associated with a normal use of the invention. The terms are used for the reader's convenience only and shall not be limiting.

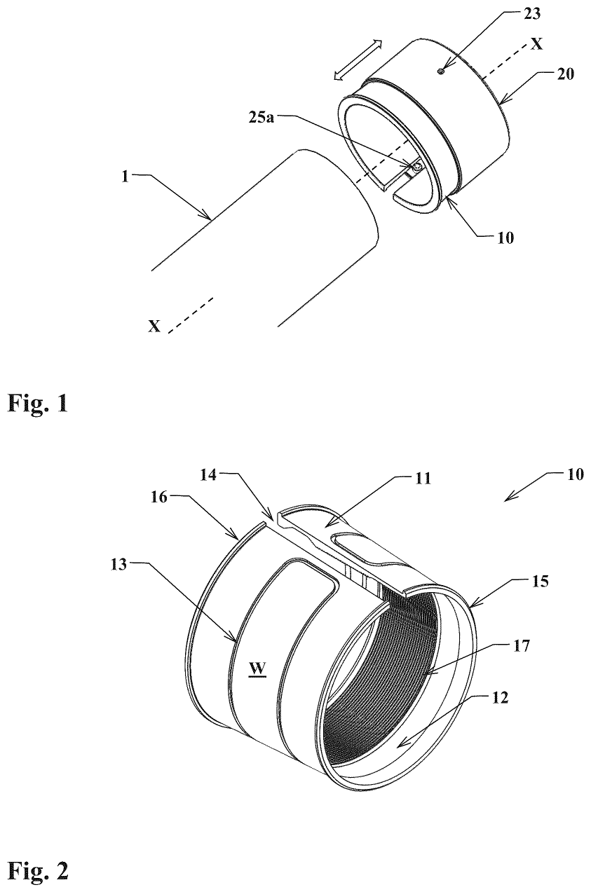

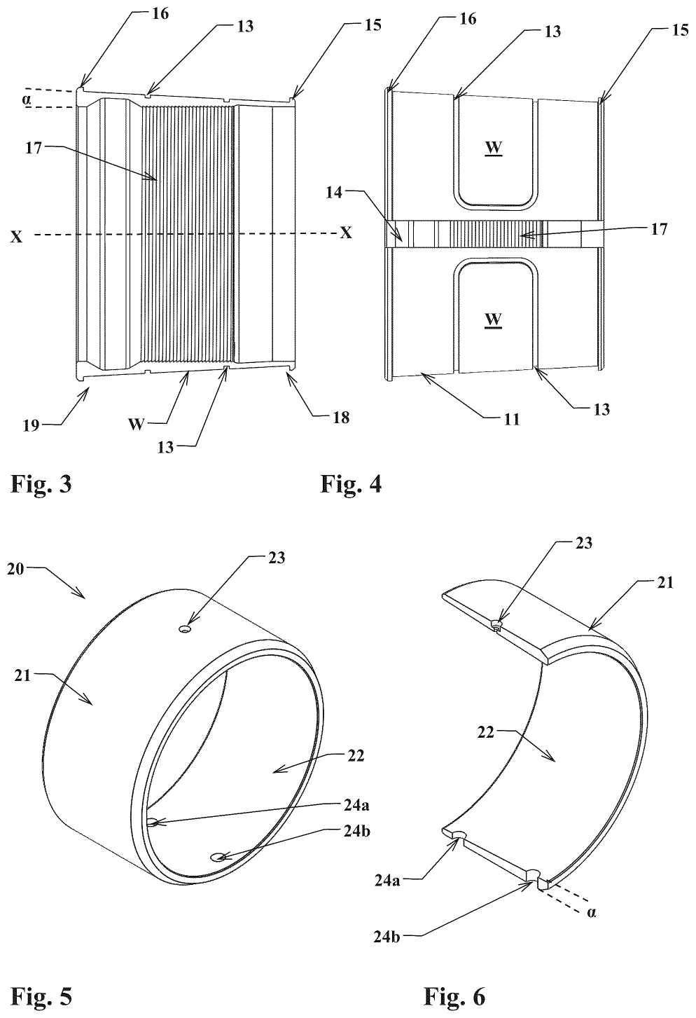

A first embodiment of the invented clamp device will now be described with reference to FIGS. 1-10. Referring initially to FIG. 1, the invented clamp device comprises an inner member 10 and an outer member 20. The outer member is closely fitted on the inner member, and is movable in the longitudinal direction (longitudinal axis X) on the inner member, as indicated by the double arrow in FIG. 1, and in a manner which is described below. The inner member is designed and formed for clamping connection to a portion of a cylindrical element 1. It will be understood that the cylindrical element 1 may be any elongated cylinder, rod, or tubular element (e.g. pipe). The cylindrical element 1, as well as the inner and outer members 10, 20, may be made of any material suited for the intended purpose. The cylindrical element 1 may be a tubular for use in a subterranean borehole, for example in a hydrocarbon reservoir or a geothermal reservoir.

Referring now to FIGS. 2-4, the inner member 10 comprises an outer surface 11 and a cylindrical inner surface 12. The inner surface is configured for clamping connection to the cylindrical element 1, and may comprise one or more friction-enhancing portions 17 for improved connection to the cylindrical element outer wall. It should be understood that such portion 17 may comprise serrations, friction-enhancing coating, or be formed by sand or glass blasting, or comprise other structures that improve friction between the inner surface and the cylindrical element. The outer surface 11 is arranged at an angle α (greater than zero) with respect to the longitudinal axis X, such that the outer surface 11 is conical with respect to the inner surface 12 and the longitudinal axis X. The inner member 10 is thus a frusto-conical member, in which outer surface 11 is cone shaped. First and second collars 15, 16 are arranged at respective first and second ends 18, 19 of the inner member. A slit 14 extends along the axial length of the inner member. A groove 13 is formed in the outer surface, defining an area W. The groove 13 is configured for receiving a gasket (not illustrated) or similar sealing device.

Referring now to FIGS. 5 and 6, the outer member 20 comprises an outer surface 21 and an inner surface 22. The inner surface 22 is arranged at an angle α with respect to the longitudinal axis X, in magnitude corresponding to the angle α on the inner member, mentioned above, such that the inner surface 22 is conical with respect to with respect to the longitudinal axis X (in the illustrated embodiment: as well as to the outer surface 21). The inner and outer members thus have the same conicity (cone angle α); the inner member having an outward-facing cone shape and the outer member having an inward-facing cone shape, the two cone shapes being complementary. A through-going hole 23 is formed in the outer member wall, preferably centrally on the outer member, as illustrated. This hole 23 is configured for injecting and withdrawing fluid, as will therefore in the following be referred to as a fluid port 23. Two through-going holes 24a,b are formed in the outer member wall, preferably diametrically opposite of the fluid port 23. These holes will in the following be referred to as receptacles 24a,b.

When the inner and outer members are assembled to form the clamp device, the outer member cone angle and the inner member cone angle are in opposite directions, such that a wedge effect is generated when the outer member is moved as indicated by the arrow in FIG. 8. The inner and outer members 10, 20 are dimensioned such that the outer member may be closely fitted on the inner member, as illustrated in e.g. FIGS. 1 and 8. In order to assemble the two members to form the clamp device, the inner member 10 may be compressed radially-which is possible by virtue of the slit 14, before the outer member is slipped onto the inner member. The dimensions are selected such that the collars 14, 15 keep the outer member on the inner member. In the assembled configuration of the clamp device, guide pins or screws 25a,b (see also FIG. 8) extend through respective receptacles 24a,b and a distance into the slit 14, thereby preventing relative rotation between the outer and inner members. The guide pins' outer diameter of the slit width are dimensioned accordingly.

In the assembled configuration of the clamp device, a sealed cavity is formed by the gasket (not shown) in the groove 13, the area W defined by the groove, and an area on the inner surface 22 of the outer member corresponding to the area W. This sealed cavity is only accessible via the fluid port 23, see also FIG. 9. The axial width of the area W, the axial position of the fluid port 23, and the cone angles α, are chosen such that the fluid port 23 remains positioned within the area W as the outer member is moved on the inner member, as described below.

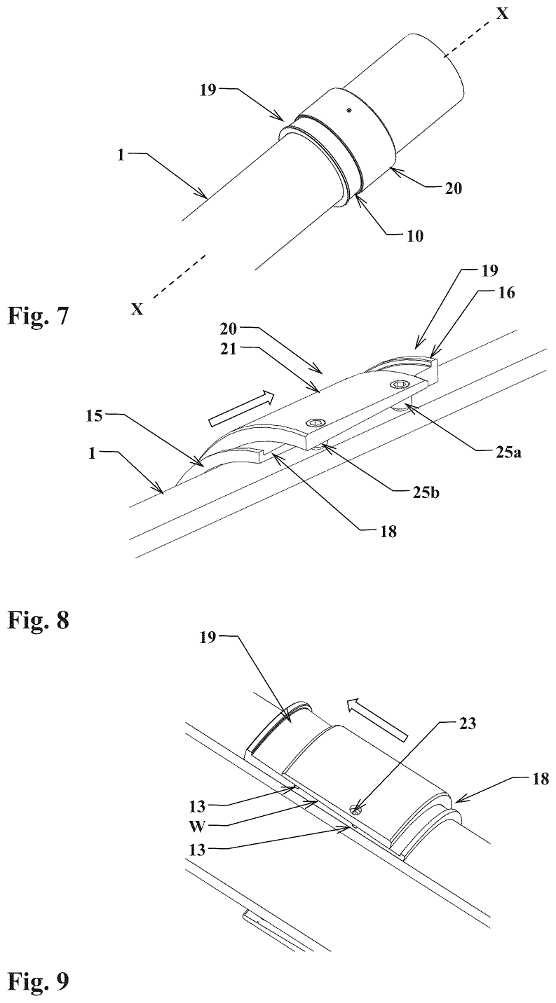

FIG. 7 illustrates an initial step in a procedure of installing the clamp device on a cylindrical element 1. The clamp device has been placed such that the inner member 10 is at a desired location on the cylindrical element. The outer member 20 is at a starting position on the inner member 10 (towards the first end 18). This step and position is also illustrated in FIG. 9, which shows how the fluid port 23 is within the area W but close to the groove 13 (with gasket or seal, not shown). As a second step in the installation procedure, a pressurized fluid is injected into the above-mentioned sealed cavity between the inner and outer members, via the fluid port 23. Parts and devices necessary to supply and control the fluid injection are not described here, as these are commonly known in the art. The fluid volume and pressure is determined by parameters such as inner and outer members' dimensions and materials, including cone angle.

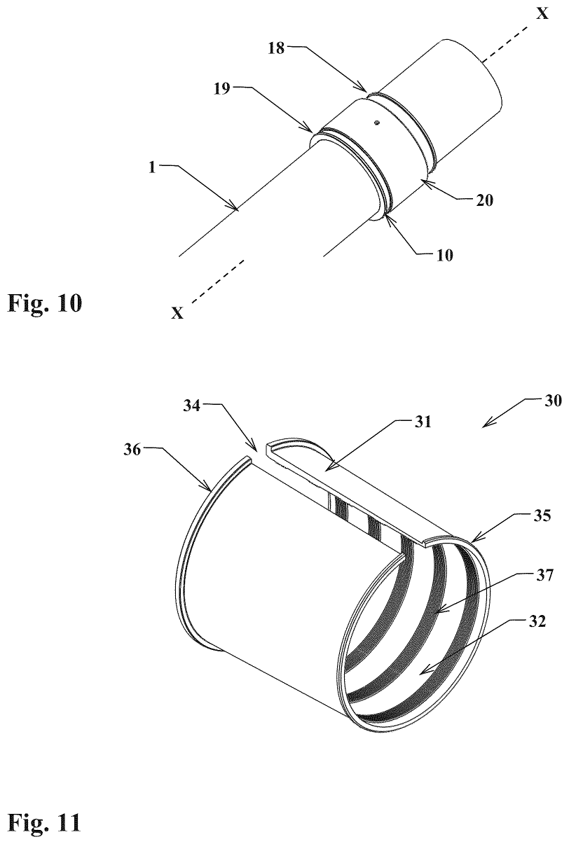

The pressurized fluid inside the sealed cavity will cause elastic deformation in the inner and outer members. But while elastic deformation of the inner member is restricted by the cylindrical element, the outer member will expand radially, allowing the outer member to be moved in a axial direction towards the inner member second end 19 (see arrows in FIGS. 8 and 9). In a practical application, designated tools and equipment (not shown) may be required to move the outer member axially and to temporarily hold the inner member. When the outer member has been moved the desired axial distance (while ensuring that the fluid port 23 remains within the area W), fluid pressure is released, causing the outer member to contract and form a tight fit with stored pretension against the inner member. The outer member inner surface and the inner member outer surface, each inclined towards each other with the cone angle α, are firmly pressed together. The clamp device is thus firmly installed on the cylindrical element, by virtue of the compressive force exerted by the outer member on the inner member. This stage is illustrated in FIG. 10. The guide pins 25a,b mentioned above by be replaced by (or may in fact be) set screws, that may be tightened against the cylindrical element when the installation procedure has been completed (see FIG. 8).

It will be understood that the cone angle α determines the range of axial movement for the outer member, and the required fluid pressure. The cone angle is inversely proportional with axial movement and proportional with fluid pressure.

The clamp device may be removed from the cylindrical element by a reverse procedure of the installation procedure, i.e. injecting a pressurized fluid into the sealed cavity to expand the outer member, move the outer member axially towards the inner member first end 18 such that the clamping action between the inner and outer members is removed, and remove the clamp device.

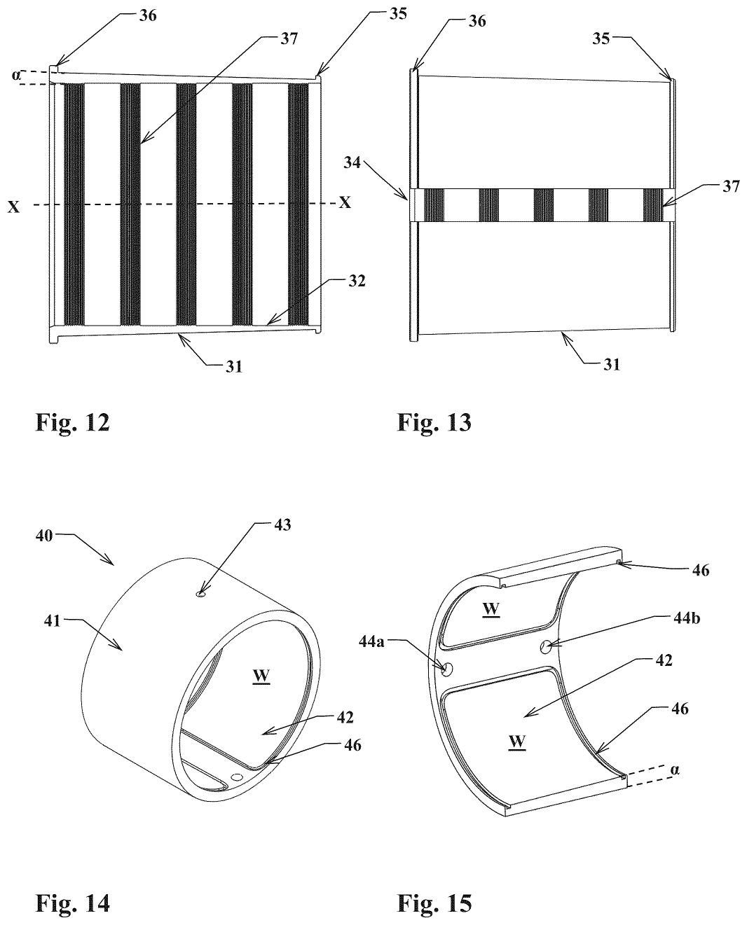

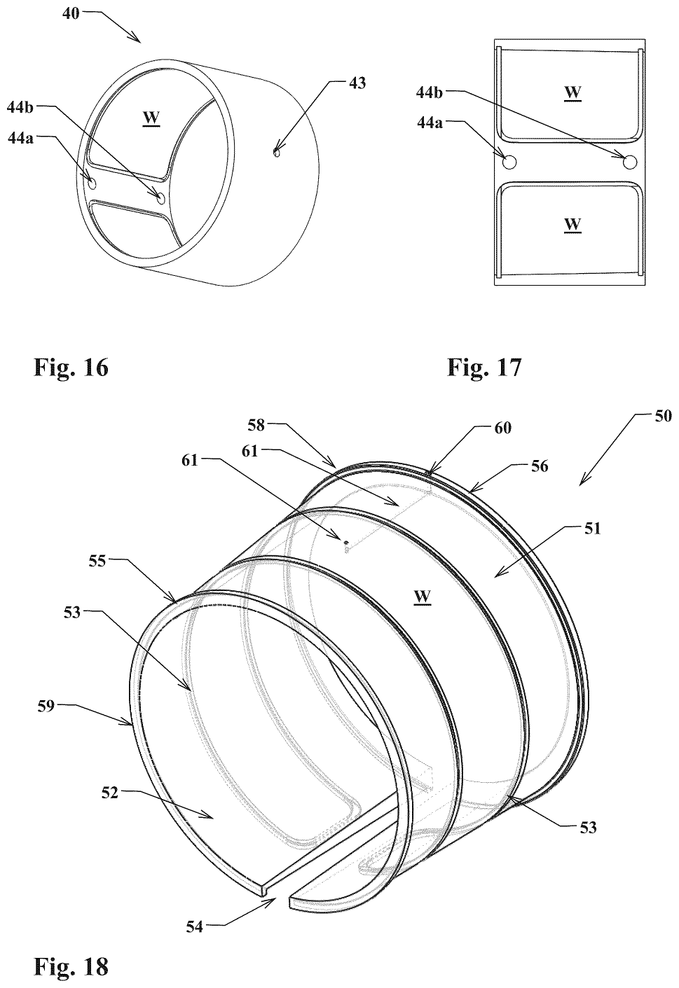

A second embodiment of the invented clamp device will now be described with reference to FIGS. 11-17. Unlike the first embodiment, the inner member 30 of the second embodiment is not furnished with a groove for a gasket or seal. Instead, the outer member 40 comprises such groove 46, that define an area W on the inner surface 42 of the outer member. The outer member comprises receptacles 44a,b for guide pins or set screws, and outer surface 41, and an injection port 43, corresponding to the similar features of the first embodiment as described above.

The inner member 30 of the second embodiment comprises an outer surface 31, an inner surface 32, a slit 34, one or more serrated portions 37 for improved connection to the cylindrical element outer wall, and first and second collars 35, 36 arranged at respective first and second ends 38, 39, all corresponding to the similar features of the first embodiment as described above. The cone angle α and the method of installing and removing the clamp device on a cylindrical element are also similar to those of the first embodiment. An advantage of arranging the groove 46 on the outer member, is that the injection port always will be within the above-mentioned sealed cavity defined by the gasket (not shown) in the groove 46, the area W defined by the groove, and an area on the inner surface 42 of the outer member corresponding to the area W.

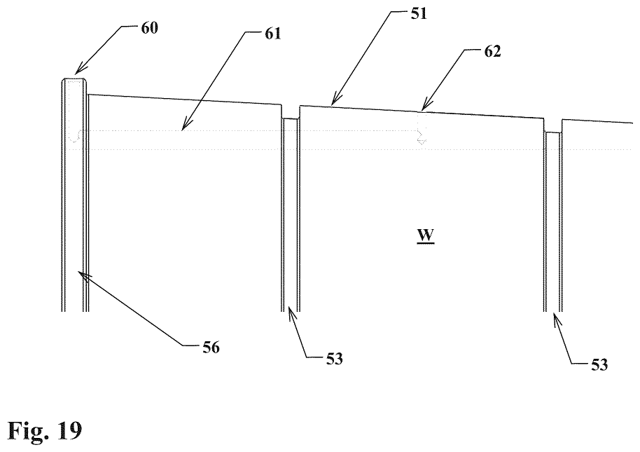

FIGS. 18 and 19 illustrate another embodiment of the inner member. This inner member 50 is similar to the embodiments 10 and 30 of the inner member described above, in that it comprises an outer surface 51 and a cylindrical inner surface 52. The inner surface is configured for clamping connection to the cylindrical element 1, and may comprise friction-enhancing portions (not shown in FIGS. 18 and 19) as described above. The outer surface 51 is conical with respect to the inner surface 12 and the longitudinal axis. First and second collars 55, 56 are arranged at respective first and second ends 58, 59. A slit 54 extends along the axial length of the inner member. A groove 53 is formed in the outer surface, defining an area W, and configured for receiving a gasket (not illustrated) or similar sealing device.

An external fluid port 60 is arranged in the first end 58 (here: in the second collar 56), and is connected to an internal fluid port 62 via a conduit 61 in the inner member wall, i.e. between the outer and inner surfaces. The internal fluid port 61 is arranged within the area W defined by the groove 53, whereby the fluid may be injected into the sealed cavity defined by the groove and respective portions of the inner and outer members when the two are assembled, in the same manner as described above with reference to the fluid ports 23, 43. It should be understood that the external fluid port may be arranged at the second end 59.

Although not illustrated, similar fluid ports and conduit may be arrangement may be arranged in the embodiment 30 of the inner member.

The embodiment 20 of the outer member may be arranged on this embodiment 50 of the inner member. In general, in one embodiment of the clamp device, the outer member need not comprise a fluid port if the inner member comprises a fluid port configuration as illustrated in FIGS. 18 and 19. However, in another embodiment of the clamp device, both the inner and outer members may comprise fluid ports. Valves, fittings and piping necessary to control the fluid injection process as described above, are not illustrated as such items are known to the skilled person.

In all embodiments of the invention, the inner and outer members comprise a material suited for the intended purpose, and may be manufactured by milling.

Although the outer members in both embodiments have been illustrated having smooth outer surfaces, it should be understood that these surfaces may be shaped and configured for connecting to or supporting miscellaneous objects or devices. As such, the outer member may comprise one or more brackets, connection devices, and/or external housings.

1. A clamp device having a longitudinal axis and comprising an inner member for assembly onto a cylindrical element, wherein the inner member comprises an inner surface for releasable contact with a portion of an outer surface of the cylindrical element;
wherein:
the inner member comprises an outer surface with an outward-facing conical shape; and
the clamp device further comprises an outer member having an inner surface defining an inward-facing conical shape;
wherein the inward-facing conical shape is complementary with the outward-facing conical shape, whereby in an assembled configuration of the clamp device, when the outer member is assembled onto the inner member, the outer member is movable in a longitudinal direction to generate a wedge effect;
wherein the inner member or the outer member comprises a sealing that define an area on the respective member, whereby the area defines a sealed cavity between the outer surface of the inner member and the inner surface of the outer member in the assembled configuration of the clamp device, when the outer member is assembled onto the inner member; and
at least one of the outer member or the inner member comprises a fluid port, whereby a fluid may be injected into the sealed cavity.

2. The clamp device of claim 1, wherein the inner member comprises one or more friction-enhancing portions for releasable engagement with a portion of the cylindrical element.

3. The clamp device of claim 1, wherein the inner member comprises a slit extending along the longitudinal axis in an entire length of the inner member.

4. The clamp device of claim 3, wherein the outer member comprises guide means that engage at least a portion of the slit, whereby the outer member is prevented from rotating around the longitudinal axis.

5. The clamp device of claim 1, wherein the inner member comprises a first collar at a first end and a second collar at a second end.

6. The clamp device of claim 1, wherein the fluid port is arranged within the area.

7. The clamp device of claim 4, wherein the fluid port and the guide means are arranged at diametrically opposite sides on the outer member.

8. A method of connecting the clamp device of claim 1, onto a cylindrical element having a longitudinal axis, comprising:
arranging the clamp device on a circumferential portion of the cylindrical element;
injecting a fluid into the sealed cavity via the fluid port, at a fluid pressure sufficient to cause temporary elastic deformation in at least the outer member;
moving the outer member axially on the inner member in order to generate a wedge effect by virtue of said conical shapes; and
releasing the fluid pressure in order to lock the elastic deformation against the cylindrical element.
